(19) United States
(12) Patent Application Publication
(10) Pub. No.: US 2008/0032611 A1
(43) Pub. Date: Feb. 7, 2008

(54) SYSTEM FOR SURFACE PREPARATION

(75) Inventor: Ricky L. Dilyard, Smithville, OH (US)

Correspondence Address: MCNEES WALLACE & NURICK LLC, 100 PINE STREET, P.O. BOX 1166, HARRISBURG, PA, 17108-1166, US

(73) Assignee: THE WOOSTER BRUSH COMPANY, Wooster, OH (US)

(21) Appl. No.: 11/831,454

(22) Filed: Jul. 31, 2007

Related U.S. Application Data
(60) Provisional application No. 60/821,013, filed on Aug. 1, 2006.

(51) Int. Cl. B05D 1/12; B24B 23/00; B24D 11/00

(52) U.S. Cl. 451/344; 427/180; 451/526

(57) ABSTRACT

A system for preparing a surface for painting, staining, or other treatment is provided. This system includes a surface preparation material and an optional dispenser for dispensing the surface preparation material. The surface preparation material includes a single-layer or multi-layer substrate material or fabric; a sanding portion formed on the substrate, wherein the sanding portion further includes at least one abrasive substance deposited thereon or embedded therein; and a wiping portion formed on the substrate separate from the sanding portion, wherein the wiping portion further includes cleaning means for removing debris created by the sanding portion from the surface to be painted, stained, or otherwise treated. The cleaning means may be one or more dry textured regions or areas formed on the substrate or it may be one or more sticky or tacky regions or areas formed on the substrate.

### CROSS-REFERENCE TO RELATED APPLICATIONS

This patent application claims the benefit of U.S. Provisional Patent Application Ser. No. 60/821,013 filed on Aug. 1, 2006 and entitled “Device and Method for Surface Preparation,” the disclosure of which is incorporated by reference as if fully rewritten herein.

### BACKGROUND OF THE INVENTION

The present invention relates generally to systems, devices, and methods for preparing surfaces for treatment, and more specifically to a product for sanding or roughing a surface and then cleaning, i.e., removing particulates and debris from, the sanded or roughed surface. Prior to treating (i.e., coating, painting, staining, etc.) a surface such as, for example, a wall, floor, door, cabinet, or area of furniture, it may be desirable to lightly sand the surface to which paint, stain, or other material will be applied. Sanding typically creates debris, usually in the form of a fine dust, which often covers, partially or wholly, the surface of interest. Because the presence of this dust can affect the final appearance of a treated surface and may interfere with the application of paint, stain, or other material, it is most often desirable to remove the dust or other debris after the surface has been sanded and before the paint, stain, or other material is applied. Because the process of sanding a surface and then cleaning that sanded surface typically requires multiple items, such as, for example, at least one piece of sand paper and at least one cleaning cloth or rag (dry and/or wet), there is a need for a more convenient means for sanding and cleaning, i.e., preparing, surfaces prior to the application of paint, stain, or other material.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a system for preparing a surface for treatment with paint, stain, or other material or substance is provided. This system includes a substantially flexible surface preparation material, which is typically formed into sheets, that has both a sanding portion and a wiping portion formed on a substrate. The sanding portion further includes at least one abrasive substance deposited on or embedded in the substrate. The wiping portion is physically and/or spatially separated from the sanding portion and further includes at least one of dry means and tacky means for removing debris created by the sanding portion from the surface or surfaces to be treated. A convenient dispenser for dispensing the flexible surface preparation material is also provided with this embodiment.

In accordance with another aspect of the present invention, an item for preparing a surface for treatment with paint, stain, or other substance is provided. This item includes a flexible or semi-flexible surface preparation material, which is typically formed into sheets or blocks, that has a sanding portion and a wiping portion, both which are been formed on a substrate. The sanding portion includes at least one abrasive substance deposited thereon or embedded therein. The wiping portion is physically and/or spatially separated from the sanding portion and further includes dry and/or tacky cleaning means in the form of an adhesive or other tacky material for removing debris created by the sanding portion from the surface or surfaces to be treated.

In yet another aspect of this invention, a method of making an item for preparing a surface for treatment is provided. This method includes the general steps of providing a substrate material, wherein the substrate material further includes a top side and a bottom side; depositing an abrasive substance on or embedding an abrasive substance within the top side of the substrate material to create a sanding portion or area on one side of the substrate material; and forming a cleaning means on the bottom portion of the substrate material to create a wiping portion or area on the opposite side of the substrate material, wherein the cleaning means captures debris created by the sanding portion on a surface being prepared for treatment.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### DETAILED DESCRIPTION OF THE INVENTION

Exemplary embodiments of the present invention are now described. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a reusable and disposable sanding and cleaning block, cloth, or multipurpose wipe that may be used to sand or rough a surface and to then clean that surface prior to the application of paint, stain, or other substances. As previously indicated, a first general embodiment of this invention provides a system for preparing a surface for treatment; a second general embodiment of this invention provides an item for preparing a surface for treatment; and a third general embodiment of this invention provides a method for making a device or apparatus for preparing a surface for treatment. One or more specific embodiments of this invention shall be described in greater detail below.

The first embodiment of this invention provides a system that includes a dual-purpose surface preparation material formed into sheets that are provided on a roll, in a box, tin, or the like. The second embodiment of this invention provides basically the same surface preparation material provided in sheet form, block form, or any other suitable and useful form. Variations in product form may be based on a variety of considerations such as, for example, the specific application for which the present invention will be used. In one form this invention is configured for use on floors or walls, while in another form this invention is configured for use on curved surfaces such as those found on furniture. Other variations are possible. In all embodiments, the surface preparation material of the present invention includes a substrate, which is typically flexible to a greater or lesser extent. One side, portion, or area of this substrate includes an abrasive substance that functions in a manner similar to sand paper when the invention is in use. Another side, portion, or area of the substrate includes a cleaning means that is used to remove any dust and debris created by the abrasive substance from the surface being prepared for treatment. The cleaning means may include a dry, textured surface designed to capture dust and debris within the texture (i.e., the three-dimensional structures comprising the texture), and/or the cleaning means may include a sticky or tacky substance deposited on the substrate that captures dust and debris by causing the dust and debris to adhere directly thereto.

The substrate included with the present invention may be any suitably durable, and for some specific applications, flexible, material. However, in the exemplary embodiments described herein, the substrate is typically one non-woven material or a combination of non-woven materials (i.e., fabrics) that are obtainable from commercial sources or that are specifically fabricated for use with this invention according to predetermined design parameters. The substrate may be a two-sided fabric that includes a single ply or layer of non-woven material or other material. Alternately, the substrate may include multiple layers of non-woven material, or other materials, bonded to one another by any of a number of processes known to those of ordinary skill in the art. In some embodiments of the present invention, at least one impermeable or substantially impermeable barrier layer is disposed between the different layers of the substrate for preventing dust and debris from sanding from passing through the substrate into the wiping and cleaning area of the surface preparation material of this invention. This barrier layer may include a non-woven material or various other impermeable or semi-impermeable materials.

The non-woven materials used with the present invention are typically created using any of a variety of known processes, including (but not necessarily limited to): spunlace (hrydroentangled), spunbond, meltblown, SMS (spunbond/meltblown/spunbond), SMMS (spunbond/meltblown/meltblown/spunbond), dry lay, wet lay, airlaid, highloft, and needlepunch processes and/or combinations thereof. The fibers used for the non-woven materials include multiple blends of natural and/or synthetic fibers or filaments including, but not limited to, single or bi-component fibers, filaments, or yarns of various cross sections, deniers, staple lengths, structures, and melt characteristics. The fibers or filaments may be natural, such as wool, silk, cotton, and other natural fibers; or the fibers may be artificial fibers such as, but not limited to, polyolefin, polyester, polypropylene, polyethylene, polyamide (nylon), acrylic, mod-acrylic, and other synthetic fibers. One or more combinations of different fiber types are possible for the substrate material of the present invention. In embodiments that include a barrier layer, polypropylene, polyethylene, polyester film or other non-woven materials may be utilized for the barrier layer. These non-woven materials may bonded together using any of a variety of known processes, including but not necessarily limited to: thermal bonding; thermal point bonding; thermal point fusion; print bonding; powder bonding; saturation bonding; spray bonding, and bonding processes involving fusion, air, calendar, mechanical bonding, chemical bonding, needlepunch, stitch bonding, ultrasound (sonic bonding), lamination, embossing, foam, resin bonding, ultraviolet light, and hydroentanglement. Non-woven materials and methods and processes associated therewith that are generally compatible with the present invention are disclosed in U.S. Pat. Nos. 5,229,191; 6,022,818; 6,103,061; all of which are incorporated by reference herein, in their entirety.

An abrasive substance deposited on and/or compressed into the substrate allows one side of the substrate (or one or more portions of the substrate) to function in a manner similar to sandpaper. The overall coarseness of this “sandpaper” may be increased or decreased by varying the grain size of the abrasive substance itself and/or varying the physical characteristics of the substrate and the method by which the abrasive substance is applied to the substrate. As will be appreciated by the skilled artisan, the grain or grit size of the sanding portion of the present invention may be varied to include extra coarse, coarse, medium, fine, very fine, extra fine, super fine, and ultra fine grains, or combinations thereof. Examples of abrasive substances compatible with this invention include: zirconium oxide, calcite (calcium carbonate), emery (impure corundum), diamond dust (including synthetic diamonds), novaculite, pumice dust, rouge, sand (quartz), borazon (cubic boron nitride or CBN), ceramic, aluminum oxide (corundum), glass powder, silicone carbide (carborundum), zirconia alumina, tungsten carbide, garnet, feldspar, and tripoli (rottenstone, a microscopic microcrystalline quartz).

The abrasive substance described above may include both natural components and synthetic or artificial components. Prior to applying the abrasive substance to the substrate, the abrasive substance is typically combined with a resin binder, a bonding agent, a paste, a cream, or a combination thereof for the purpose of creating a fluid or semi-fluid composition. This composition is then applied to the substrate using a variety of known methods (or a combination of known methods), including but not necessarily limited to: roll screening, print screening, spraying, saturation, foam, print, coating, dip, or powder bonding. Resins, abrasives, and various methods and processes associated therewith that are generally compatible with the present invention are disclosed in U.S. Pat. Nos. 4,227,350; 4,314,827; 5,363,604; and 5,585,438, all of which are incorporated by reference herein, in their entirety.

In addition to the sanding portion that is formed on one portion of the surface preparation material of the present invention, a wiping portion is formed on another portion of the surface preparation material for capturing and removing dust and debris created by the sanding portion. The wiping portion may be formed on the side of the surface preparation material that is opposite the sanding portion (e.g., on the back or on the bottom of a sheet or block of the surface preparation material, wherein the sanding portion is on the front or the top of the sheet or block). In one embodiment, the sanding portion and wiping portion are formed on the same surface of the surface preparation material; however, the two portions are physically separate from one another. In another embodiment, the sanding portion and wiping portions are formed on adjacent surfaces that are angled away from one another (e.g., at substantially right angles). The wiping portion includes a cleaning means that in one embodiment is a dry, at least partially textured surface formed on or in the wiping portion. In another embodiment, the cleaning means is a sticky, tacky, or adhesive substance deposited on or embedded within the wiping portion.

In the embodiment of this invention wherein the cleaning means includes a dry surface formed on the substrate, the cleaning means may simply be the substrate itself, which typically includes at least some degree of texturing due to the general nature of fabrics and due to the nature of non-woven fabrics, in particular. Alternately, one side of the substrate (or another ply or layer attached to or incorporated into the substrate) may be fabricated to specifically include any of a variety of three-dimensional structures that provide additional surface area on the wiping portion for capturing and removing dust and debris. See, for example, the textured non-woven materials disclosed in U.S. Pat. No. 6,675,429 and U.S. Pat. Pub. No. US 2004/0248493, both which are incorporated by reference herein, in their entirety. Textures used with this invention may include webs, ridges, valleys, or other geometric shapes and structures that effectively capture and retain dust particulates and other debris from a sanded surface that has been rubbed or wiped with the textured portion. With this embodiment, it is not typically necessary to wet the wiping portion to remove unwanted dust and debris from a sanded or roughed item.

In the embodiment of this invention wherein the cleaning means includes a sticky, tacky, or adhesive substance deposited on or embedded within the wiping portion, a variety of appropriately sticky or tacky adhesive substances may be used, and such substances may be sprayed or otherwise transferred onto the substrate. The adhesive substance is typically free of silicone, wax, and paraffin and may be a low tack resin, a low tack adhesive, a low tack polymer or co-polymer, low tack pressure sensitive adhesive, or a combination thereof. The adhesive may be polybutene, polyisobutylene, vinyl acetate (latex), acrylate, methyl methacrylate, butyl acrylate, styrene, acrylic, methacrylate, polyvinyl alcohol (PVA), organic resin, or a combination thereof. Regarding the tacky or sticky cleaning surface; materials, methods and processes that are generally compatible with the present invention are disclosed in U.S. Pat. Nos. 5,198,292; 6,746,974; 6,808,791; and D487, 353 and Pat. Pub. Nos. US 2002/0160157; US 2002/0164465; US 2005/0014434; US 2005/0266752; US 2006/0135012; and US 2006/0240223, all of which are incorporated by reference herein, in their entirety.

In each of the described embodiments, the present invention may be provided in the form of individual sheets or units, individual sheets or units placed in a box, tin, or poly bag similar to a box of tissues, or in the form of a roll of sheets having perforated or scored edges similar to a roll of paper towels. Individual sheets may be foldable or pre-folded to provide multiple usable surfaces on a single sheet and/or to facilitate removal of a sheet from a container such as a box. A user of the present invention uses the sanding portion on a single cloth or wipe to lightly sand or rough a surface that is to be painted, stained, or otherwise treated. After the surface has been sanded, the user flips the cloth over and uses at least a portion of the wiping portion to remove dust and other debris created by the sanding step. When either the sanding portion or the wiping portion loses its effectiveness (as with repeated use), the entire cloth may be discarded in favor of a new cloth.

Having generally described this invention, a further understanding can be obtained by reference to certain specific examples detailed below, which are provided for purposes of illustration only and are not intended to be all inclusive or limiting unless otherwise specified.

### EXAMPLE 1

| | Non-Woven Substrate | | Abrasive Material | |
|---|---|---|---|---|
| Abrasive Layer | Fiber Composition | 70% polyester fiber | Material | Corundum |
| | | 30% nylon fiber | | (Aluminum oxide) |
| | Thickness | 12 mils (.012) | Grit Designation | Fine (F) 180-220 |
| | Construction | Spunbond/Point Bonded | Composition | Resin binder, |
| | | Continuous Web | | bonding agent, |
| | | | | paste or cream |
| | Substrate | | | |
| Barrier Layer | Material | Polypropylene film | | |
| | Film Thickness | 1.5 mils (.0015) | | |
| | Construction | Continuous film | | |
| | Non-Woven Substrate | | Tacky/Adhesive Material | |
| Wiping Layer | Fiber Composition | 80% polyester fiber | Material | Methyl methacrylate |
| | | 20% rayon fiber | | |
| | Thickness | 10 mils (.010) | Characteristics | Low tack |
| | Construction | Spunlace/Hydroentangled | Deposition Method | Spray or |
| | | Continuous Web | | Roll coat |

### EXAMPLE 2

| | Non-Woven Substrate | | Abrasive Material | |
|---|---|---|---|---|
| Abrasive Layer | Fiber Composition | 70% polyester fiber | Material | Carborundum |
| | | 30% nylon fiber | | (Silcon carbide) |
| | Thickness | 12 mils (.012) | Grit Designation | Fine (F) 180-220 |
| | Construction | Spunbond | Composition | Resin binder, |
| | | Continuous Web | | bonding agent, |
| | | | | paste or cream |
| | Substrate | | | |
| Barrier Layer | Material | Spunbond polyester | | |
| | Film Thickness | 1.5 mils (.0015) | | |
| | Construction | Continuous film | | |
| | Non-Woven Substrate | | Tacky/Adhesive Material | |
| Wiping Layer | Fiber Composition | 80% polyester fiber | Material | Butyl acrylate |
| | | 20% rayon fiber | | |
| | Thickness | 10 mils (.010) | Characteristics | Low tack |
| | Construction | Spunlace/Hydroentangled | Deposition Method | Spray or |
| | | Continuous Web | | Roll coat |

### EXAMPLE 3

| | Non-Woven Substrate | | Abrasive Material | |
|---|---|---|---|---|
| Abrasive Layer | Fiber Composition | 70% polyester fiber | Material | Carborundum |
| | | 30% nylon fiber | | (Silcon carbide) |
| | Thickness | 12 mils (.012) | Grit Designation | Fine (F) 180-220 |
| | Construction | Spunbond/Point Bonded | Composition | Resin binder, |
| | | Continuous Web | | bonding agent, |
| | | | | paste or cream |
| | Substrate | | | |
| Barrier Layer | Material | Polypropylene film | | |
| | Film Thickness | 1.5 mils (.0015) | | |
| | Construction | Continuous film | | |
| | Non-Woven Substrate | | Tacky/Adhesive Material | |
| Wiping Layer | Fiber Composition | 100% polyester fiber | Material | Polymer |
| | Thickness | 10 mils (.010) | Characteristics | Low tack |
| | Construction | Spunlace/Hydroentangled | Deposition Method | Spray or |
| | | Continuous Web | | Roll coat |

### EXAMPLE 4

| | Non-Woven Substrate | | Abrasive Material | |
|---|---|---|---|---|
| Abrasive Layer | Fiber Composition | 100% nylon | Material | Corundum |
| | | | | (Aluminum oxide) |
| | Thickness | 50 mils | Grit Designation | Fine (F) 180-220 |
| | Construction | Needlepunched high loft | Composition | Resin binder, |
| | | Continuous Web | | bonding agent, |
| | | | | paste or cream |
| | Substrate | | | |
| Barrier Layer | Material | Spunbond | | |
| | | Polyester/Polypropylene | | |
| | Film Thickness | 1.5 mils (.0015) | | |
| | Construction | Continuous film | | |
| | Non-Woven Substrate | | Tacky/Adhesive Material | |
| Wiping Layer | Fiber Composition | 100% polyester | Material | Copolymer |
| | Thickness | 10 mils (.010) | Characteristics | Low tack |
| | Construction | Spunbond | Deposition Method | Spray or |
| | | Continuous Web | | Roll coat |

In examples 1-4, the abrasive layer, barrier layer, and wiping layer are typically thermally point bonded together through the simultaneous application of heat and pressure in a calendar nip roll, although other suitable processes may be utilized. The abrasive material is applied to the non-woven substrate of the abrasive layer using a perforated print roll screen and is then bonded to the non-woven substrate of the abrasive layer by applying both heat and pressure with a calendar nip roll or other device. The tacky/adhesive material is typically sprayed or roll coated onto the non-woven substrate of the wiping layer.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A system for preparing a surface for treatment, comprising:
(a) a surface preparation material, wherein the surface preparation material further includes:
(i) a substrate;
(ii) a sanding portion formed on the substrate, wherein the sanding portion further includes at least one abrasive substance deposited thereon or embedded therein; and
(iii) a wiping portion formed on the substrate separate from the sanding portion, wherein the wiping portion further includes cleaning means for capturing and removing debris created by the sanding portion from the surface to be treated; and
(b) a dispenser for dispensing the surface preparation material.

2. The system of claim 1, wherein the surface preparation material is manufactured in sheets.

3. The system of claim 1, wherein the substrate further includes an at least one-ply, at least two-sided non-woven material.

4. The system of claim 3, wherein the non-woven material further includes at least one of natural fibers and synthetic fibers, wherein the natural fibers are selected from the group consisting of wool, silk, cotton, and combinations thereof; and wherein the synthetic fibers are selected from the group consisting of: polyolefin, polyester, polypropylene, polyethylene, polyamide, acrylic, mod-acrylic, and combinations thereof.

5. The system of claim 3, wherein the non-woven material is a spunlace fabric, a spunbond fabric, a meltblown fabric, an SMS fabric, an SMMS fabric, a dry lay fabric, a wet lay fabric, an airlaid fabric, a highloft fabric, a needlepunch fabric, or a combination thereof.

6. The system of claim 1, wherein the sanding portion further includes a grit size selected from the group consisting of extra coarse, coarse, medium, fine, very fine, extra fine, super fine, and ultra fine.

7. The system of claim 1, wherein the abrasive substance is selected from the group consisting of chromium oxide, zirconium oxide, calcium carbonate, emery, diamond dust, novaculite, pumice dust, rouge, sand, borazon, ceramic, corundum, glass powder, silicone carbide, alumina-zirconia, tungsten carbide, garnet, feldspar, tripoli, and combinations thereof.

8. The system of claim 1, wherein the abrasive substance further includes at least one of natural particles and synthetic particles, and wherein the particles have been combined with a material selected from a group consisting of resins, binders, bonding agents, pastes, creams, and combinations thereof prior to deposition on the substrate.

9. The system of claim 1, wherein the abrasive substance has been deposited on or embedding within the sanding portion by roll screening, print screening, spraying, saturation, foaming, printing, coating, dipping, powder bonding, or combinations thereof.

10. The system of claim 1, wherein the cleaning means further includes a dry, at least partially textured surface formed on the wiping portion.

11. The system of claim 1, wherein the cleaning means further includes a sticky, tacky, or adhesive substance deposited on or embedded within the wiping portion.

12. The system of claim 1, wherein the cleaning means further includes at least one low tack resin, at least one low tack adhesive, at least one low tack polymer or co-polymer, at least one low tack pressure sensitive adhesive, or combinations thereof.

13. The system of claim 1, wherein the cleaning means further includes: polybutene, polyisobutylene, vinyl acetate, acrylates, methyl methacrylate, butyl acrylate, styrene, acrylics, methacrylates, polyvinyl alcohol, organic resins, or combinations thereof.

14. The system of claim 1, wherein the dispenser further includes a roll, tin, or a box.

15. An item for preparing a surface for treatment, comprising:
(a) a substrate;
(b) a sanding portion formed on the substrate, wherein the sanding portion further includes at least one abrasive substance deposited thereon or embedded therein; and
(c) a wiping portion formed on the substrate separate from the sanding portion, wherein the wiping portion further includes cleaning means for capturing and removing debris created by the sanding portion from the surface to be treated.

16. The item of claim 15, wherein the item is manufactured in rolls or in individual sheets.

17. The item of claim 15, wherein the substrate further includes an at least one-ply, at least two-sided, non-woven material.

18. The item of claim 17, wherein the non-woven material further includes at least one of natural fibers and synthetic fibers, wherein the natural fibers are selected from the group consisting of wool, silk, cotton, and combinations thereof; and wherein the synthetic fibers are selected from the group consisting of: polyolefin, polyester, polypropylene, polyethylene, polyamide, acrylic, mod-acrylic, and combinations thereof.

19. The item of claim 17, wherein the non-woven material is a spunlace fabric, a spunbond fabric, a meltblown fabric, an SMS fabric, an SMMS fabric, a dry lay fabric, a wet lay fabric, an airlaid fabric, a highloft fabric, a needlepunch fabric, or a combination thereof.

20. The item of claim 15, wherein the sanding portion further includes a grit size selected from the group consisting of extra coarse, coarse, medium, fine, very fine, extra fine, super fine, and ultra fine.

21. The item of claim 15, wherein the abrasive substance is selected from the group consisting of chromium oxide, zirconium oxide, calcium carbonate, emery, diamond dust, novaculite, pumice dust, rouge, sand, borazon, ceramic, corundum, glass powder, silicone carbide, alumina-zirconia, tungsten carbide, garnet, feldspar, tripoli, and combinations thereof.

22. The item of claim 15, wherein the abrasive substance further includes at least one of natural particles and synthetic particles, and wherein the particles have been combined with a material selected from the group consisting of resins, binders, bonding agents, pastes, creams, and combinations thereof.

23. The item of claim 15, wherein the abrasive substance has been deposited on or embedding within the sanding portion by roll screening, print screening, spraying, saturation, foaming, printing, coating, dipping, powder bonding, or combinations thereof.

24. The item of claim 15, wherein the cleaning means further includes a dry, at least partially textured surface formed on the wiping portion.

25. The item of claim 15, wherein the cleaning means further includes a sticky, tacky, or adhesive substance deposited on or embedded within the wiping portion.

26. The item of claim 15, wherein the cleaning means further includes at least one low tack resin, at least one low tack adhesive, at least one low tack polymer or co-polymer, at least one low tack pressure sensitive adhesive, or combinations thereof.

27. The item of claim 15, wherein the cleaning means further includes: polybutene, polyisobutylene, vinyl acetate, acrylates, methyl methacrylate, butyl acrylate, styrene, acrylics, methacrylates, polyvinyl alcohol, organic resins, or combinations thereof.

28. A method of making an item for preparing a surface for treatment, comprising:
(a) providing a substrate material, wherein the substrate material further includes a top side and a bottom side;
(b) depositing an abrasive substance on or embedding an abrasive substance within the top side of the substrate material to create a sanding portion on one side of the substrate material; and
(c) forming a cleaning means on the bottom side of the substrate material to create a wiping portion on the opposite side of the substrate material, wherein the cleaning means captures and removes debris created by the sanding portion on a surface being prepared for treatment.

29. The method of claim 28, wherein the substrate material is a single-layer non-woven material.

30. The method of claim 28, wherein the substrate material is a multiple-layer non-woven material.

31. The method of claim 30, wherein the substrate material further includes at least one substantially impermeable barrier layer disposed between the multiple layers of the substrate material.

32. The method of claim 28, wherein the abrasive substance is selected from the group consisting of chromium oxide, zirconium oxide, calcium carbonate, emery, diamond dust, novaculite, pumice dust, rouge, sand, borazon, ceramic, corundum, glass powder, silicone carbide, alumina-zirconia, tungsten carbide, garnet, feldspar, tripoli, and combinations thereof.

33. The method of claim 28, wherein the cleaning means further includes a dry, at least partially textured surface.

34. The method of claim 28, wherein the cleaning means further includes a sticky, tacky, or adhesive substance.

35. The method of claim 28, wherein the cleaning means further includes at least one low tack resin, at least one low tack adhesive, at least one low tack polymer or co-polymer, at least one low tack pressure sensitive adhesive, or combinations thereof.
